(19) United States
(12) Patent Application Publication
(10) Pub. No.: US 2021/0256014 A1
(43) Pub. Date: Aug. 19, 2021

(54) SYSTEM FOR DATA ENGINEERING AND DATA SCIENCE PROCESS MANAGEMENT

(71) Applicant: Semantix Tecnologia em Sistema de Informação S.A, Sao Paulo (BR)

(72) Inventor: Leonardo Dos Santos Poça Dágua, Sao Paulo (BR)

(73) Assignee: Semantix Tecnologia em Sistema de Informação S.A, Sao Paulo (BR)

(21) Appl. No.: 17/178,180

(22) Filed: Feb. 17, 2021

(30) Foreign Application Priority Data
Feb. 17, 2020 (BR) BR 10 2020 003282

(51) Int. Cl. G06F 16/23; G06F 16/245

(52) U.S. Cl. CPC G06F 16/2379; G06F 16/245

(57) ABSTRACT

Big data platform for data processing. An exemplary system for managing data engineering and data science processes referenced herein includes an input application module configured to read data inputs from data sources, a processing module configured to apply functions of data science and data engineering processing on the data inputs, a storage module configured to store data inputs, processed data, and output data, an output application module configured to collect the processed data and writes data outputs, an orchestrator module configured to manage the dataflow with predefined rules on which modules to be triggered in accordance with the data inputs and data outputs, and a messaging module configured to communicate the processing module and the orchestrator module.

### PRIORITY

The present application is related to, and claims the priority benefit of, Brazilian Patent Application Serial No. BR 10 2020 003282 8, filed Feb. 17, 2020, the contents of which are incorporated herein in their entirety.

### TECHNICAL FIELD

This present disclosure relates to Big data and Data Science.

### BACKGROUND

Big Data technologies have been adopted by small and large companies for years. The most used systems for data pipelines follow three main processes related to data, namely collection, management, and analysis.

Even though different industries and projects have their own requirements regarding timelines, robustness, and throughput, components that manage and analyze data could be organized in a well-defined architecture ready to be reused in different projects.

In data pipelines comprised in the state of the art, each new project requires a new architecture to be specifically designed according to the project's requirements.

The state of the art lacks an architecture capable of adapting to different big data and data sciences projects in a single system.

### BRIEF SUMMARY

The present disclosure includes disclosure of various systems, such as a system providing a flexible big data architecture that exploits intermediary computer program modules and available technologies to process large amounts of data in parallel. This architecture fits the main principles of big data related to data science and engineering, namely data storage, data maintenance, data discovery, and data analysis. As the system stores data and provide connections to external systems via APIs (Application Programming Interfaces), it is possible to visualize current results and elaborate late analysis.

Exemplary systems of the present disclosure provide an orchestrator component that brings flexibility to the design of any data transformation or analysis pipelines. Due to the orchestration service, the architecture can be flexible to any data processing pipelines and its components guarantee resilience without being impacted by the amount of data received by the architecture.

The present disclosure includes disclosure of a system for managing data engineering and data science processes, comprising an input application module configured to read data inputs from data sources, a processing module configured to apply functions of data science and data engineering processing on the data inputs, a storage module configured to store data inputs, processed data, and output data, an output application module configured to collect the processed data and writes data outputs, an orchestrator module configured to manage the dataflow with predefined rules on which modules to be triggered in accordance with the data inputs and data outputs, and a messaging module configured to communicate the processing module and the orchestrator module.

The present disclosure includes disclosure of a system for managing data engineering and data science processes, wherein the orchestrator module comprises a memory unit which stores the predefined rules on which modules to be triggered in accordance with the data inputs and data outputs.

The present disclosure includes disclosure of a system for managing data engineering and data science processes, wherein the orchestrator module comprises a memory unit which stores the address of each module.

The present disclosure includes disclosure of a system for managing data engineering and data science processes, wherein the processing module comprises a data engineering block and a data science block.

The present disclosure includes disclosure of a system for managing data engineering and data science processes, wherein the storage module comprises an in-memory database, an online object storage element, and a search engine database.

The present disclosure includes disclosure of a system for managing data engineering and data science processes, wherein the storage module comprises an in-memory database which stores text data, an online object storage element which stores binary files, and a search engine database which stores track files of system logs and text outputs.

The present disclosure includes disclosure of a system for managing data engineering and data science processes, wherein the processing module is configured to apply multiple functions of data engineering and data science simultaneously.

The present disclosure includes disclosure of a system for managing data engineering and data science processes, wherein the predefined rules involve one or more rules for organizing the sequence of processes to be applied to the data after the extraction of the data from the data source, wherein the one or more predefined rules define a batch process or a real-time process, and wherein the one or more sequence rules comprise rules for parsing, transforming and analyzing the data.

The present disclosure includes disclosure of a system for managing data engineering and data science processes, wherein the processing module process each of the multiple data records in near real-time, preferably by the processing engine the results from previous processes.

The present disclosure includes disclosure of a non-transitory computer-readable storage medium having computer-executable instructions stored thereon for, when executed by a processor of a computer, performing a method for managing data engineering and data science processes, the method comprising reading data inputs from data sources using an input application module, applying functions of data science and data engineering processing on the data inputs using a processing module configured to apply the functions of data science and data engineering, storing data inputs, processed data, and output data on a storage module, collecting the processed data and writes data outputs using an output application module, managing the dataflow with predefined rules on which modules to be triggered in accordance with the data inputs and data outputs using an orchestrator module, and communicating the processing module and the orchestrator module using a messaging module.

The present disclosure includes disclosure of a method of performing a method for managing data engineering and data science processes, comprising the steps of reading data inputs from data sources using an input application module, applying functions of data science and data engineering processing on the data inputs using a processing module configured to apply the functions of data science and data engineering, storing data inputs, processed data, and output data on a storage module, collecting the processed data and writes data outputs using an output application module, managing the dataflow with predefined rules on which modules to be triggered in accordance with the data inputs and data outputs using an orchestrator module, and communicating the processing module and the orchestrator module using a messaging module.

The present disclosure includes disclosure of a method of performing a method for managing data engineering and data science processes, wherein the orchestrator module comprises a memory unit which stores the predefined rules on which modules to be triggered in accordance with the data inputs and data outputs.

The present disclosure includes disclosure of a method of performing a method for managing data engineering and data science processes, wherein the step of managing the dataflow is performed using the orchestrator module that comprises a memory unit which stores the address of each module.

The present disclosure includes disclosure of a method of performing a method for managing data engineering and data science processes, wherein the processing module comprises a data engineering block and a data science block.

The present disclosure includes disclosure of a method of performing a method for managing data engineering and data science processes, wherein the storage module comprises an in-memory database, an online object storage element, and a search engine database.

The present disclosure includes disclosure of a method of performing a method for managing data engineering and data science processes, wherein the storage module comprises an in-memory database which stores text data, an online object storage element which stores binary files, and a search engine database which stores track files of system logs and text outputs.

The present disclosure includes disclosure of a method of performing a method for managing data engineering and data science processes, wherein the processing module is configured to apply multiple functions of data engineering and data science simultaneously.

The present disclosure includes disclosure of a method of performing a method for managing data engineering and data science processes, wherein the predefined rules involve one or more rules for organizing the sequence of processes to be applied to the data after the extraction of the data from the data source, wherein the one or more predefined rules define a batch process or a real-time process, and wherein the one or more sequence rules comprise rules for parsing, transforming and analyzing the data.

The present disclosure includes disclosure of a method of performing a method for managing data engineering and data science processes, wherein the processing module process each of the multiple data records in near real-time, preferably by the processing engine the results from previous processes.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 depicts a diagram of the system configured for a general embodiment, according to an exemplary embodiment of the present disclosure; and

FIG. 2 depicts a detailed diagram of task parallelization within the architecture, according to an exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of a system 100 (which can also be referred to herein in some embodiments as a computer or other device or system having a microprocessor or processor configured to perform instructions (software) stored upon a storage medium in communication therewith) arranged to process data from a variety of data sources, in a scalable and parallelizable way. The disclosed systems manage data science and data engineering processes in a parallel computing architecture, in a style to provide flexibility for different applications, while maintaining a fixed set of components used in a well-defined architecture that controls the dataflow and guarantees the conclusion of processes.

An exemplary system 100, in accordance with the present disclosure, comprises an input application module 140, configured to collect data from a data source. Once data is collected by the input application module 140, an orchestrator module 110 is triggered. The orchestrator module 110 is configured to manage dataflow, and is responsible for receiving the status of other components in the system 100, triggering the processing of data parsing, data transformation, and data analysis functions, managing the flow of transformations of the data in the pipeline and storing the location of the data in the database system. According to the present disclosure, the orchestrator module 110 is the only component that directly communicates with other components in the pipeline, making all the communication between data acquisition, data transformation, data analysis and output modules indirect. The remaining components of the system 100, according to the present disclosure and generally referred to as the processing blocks, hold all data engineering and data science functions in the pipeline, performing all transformation and inference in the data. Although the processing block's functions will vary depending on the use of the system 100, the communication structure with these processing blocks, the Orchestrator module 110 and the storage system, will remain the same. The system 100, according to the present disclosure, also comprises an output application module 150, which writes system logs to a storage system, gathers enhanced data in previous steps and sends it to an output streaming or storage system.

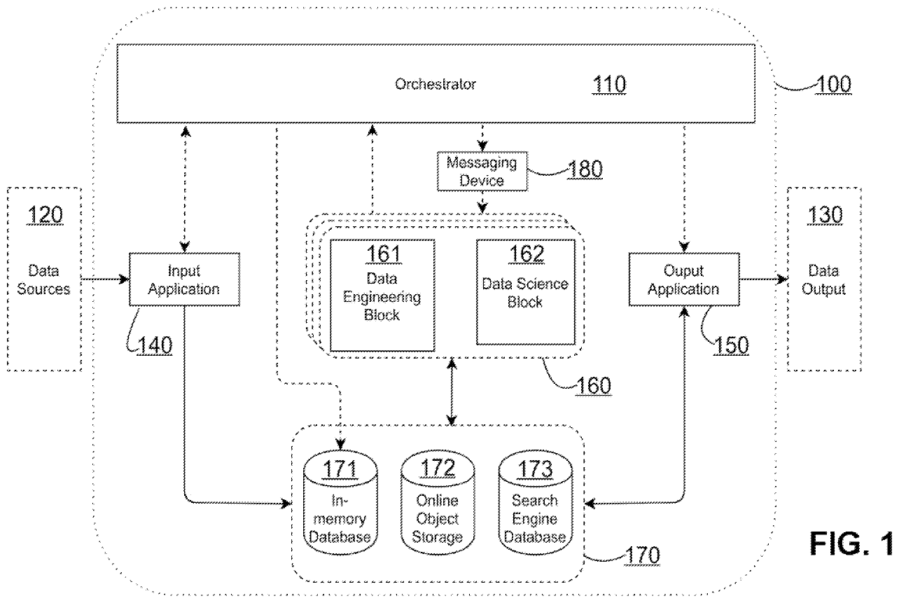

In FIG. 1 is depicted the architecture of a system 100 in accordance with the present disclosure, to deploy data engineering and data science processes in a scalable manner. The system 100 illustrated in FIG. 1 includes an orchestrator module 110, which involves commercially known programming tools that allow the communication and integration of different hardware devices, APIs (Application Programming Interfaces), and online services. The system 100 also includes an input application module 140 designed to receive raw data from data sources 120. The raw data can be in the form of batch loads or streaming data. The system 100 also includes an output application module 150 designed to send process results to a data output 130 destination once communicated by the orchestrator module 110.

The orchestrator module 110 is a fixed structure responsible for managing the pipelines of the system 100. The orchestrator module 110 is configured to manage the dataflow with predefined rules on which modules to be triggered in accordance with the data inputs and data outputs. The orchestrator module 110 comprises a memory unit 111, which carries a file containing the address of each input application module 140, output application module 150, a processing module 160, a storage module 170 and a messaging module 180, and pre-defined required steps to finish each specific pipeline. The memory unit 111 of the orchestrator module 110 comprises information on which sub-modules will participate in every pipeline and it can deal with multiple pipelines in tandem by handling several configuration files, one for each pipeline. The memory unit 111 comprises predefined rules on which modules to be triggered depending on the data input and data output, as well as the data science and data engineering processes to be conducted.

In a preferred embodiment, the predefined rules involve one or more rules for organizing the sequence of processes to be applied to the data after the extraction of the data from the data source, wherein the one or more predefined rules define a batch process or a real-time process, and the one or more sequence rules comprise rules for parsing, transforming and analyzing the data.

The orchestrator module 110 is engaged to give flexibility to the system 100, while the other sub-modules, input application module 140, output application module 150, processing module 160, storage module 170, and messaging module 180, will give scalability to the system 100.

The input application module 140 reads raw data from a configured data source 120, writes raw data in the storage module 170, and communicates the orchestrator module 110 that data is ready to be analyzed by other pipeline elements. The input application module 140 involves using an open-source framework to support scalability to the data analysis.

The output application module 150 is configured to collect the processed data and writes data outputs. More specifically, the output application module 150 collects the enhanced data from the storage module 170 after receiving instructions from the orchestrator module 110. The enhanced data is finally written to a configured data output 130 and pipeline logs are saved in the storage module 170. The output application module 150 involves using an open-source framework to support scalability to the data output process.

An exemplary system 100 of the present disclosure includes a processing module 160 which receives instructions from the orchestrator module 110 and is configured to apply functions of data science and data engineering processing on the data inputs, to transform or process data according to the task at hand. The processing module 160 might be composed of a data engineering block 161, a data science block 162, or a combination of both. The data engineering block 161 and the data science block 162 involve commercially known programming tools. The system uses a serverless framework that allows the deployment of functions and code that can run on top of different infrastructures.

In a preferred embodiment, the processing module 160 process each of the multiple data records in near real-time, preferably by the processing engine the results from previous processes.

Exemplary systems 100 according to the present disclosure also include a storage module 170 configured to store data inputs, processed data, and output data. The storage module 170 may be composed of one or more of three different devices, namely an in-memory database 171, an online object storage element 172, and a search engine database 173. These devices 171, 172, and 173 communicate with input application module 140, orchestration module 110, processing module 160, and output application module 150. The storage module 170 stores all raw and processed data in initial, intermediate and final stages of the pipeline, and stores the pipeline status and logs of said process(es).

An exemplary system 100 of the present disclosure also includes a messaging module 180 that is configured to communicate the processing module 160 and the orchestrator module 110. The messaging module 180 triggers processing module 160 according to commands given by orchestration module 110. The messaging module 180 involves a commercially known programming tool that treats multiple messages from multiple producers and multiple consumer devices.

In a preferred embodiment, the storage module 170 is configured to store data inputs, processed data, and output data. In at least one embodiment, the storage module 170 comprises an in-memory database 171. The in-memory database 171 involves an in-memory key-store database which supports non-binary files such as strings, hashes, lists, etc. Besides its use as a database, the in-memory database 171 can also be used as an additional messaging device to keep track of pipeline status. The storage module 170 may also include an online object storage element 172 that is exclusively used for binary files such as media data. The storage module 170 may also include a search engine database 173 to store system and error logs.

In a preferred embodiment, the processing module 160 can be composed of several sub-processing functions that may be instructed by the orchestrator module 110 to operate in sequence or in parallel.

In a preferred embodiment, the processing module 160 may consist of only a Data Engineering block 161, which performs data engineering processes wherein data is transformed.

In an alternative embodiment, the processing module 160 may consist of only a data science block 162, which performs data science processes wherein data is used as input in an analytic workflow.

In a preferred embodiment, in-memory database 171, online object storage element 172, and the search engine database 173 are interchangeably used. Binary files are stored and consumed in the online object storage 172. Text data is stored and consumed in the in-memory database 171. The search engine storage service 173 is used to keep track of system logs and text outputs.

In a preferred embodiment, the system 100 can be used to extract text, which would be a data output 130, from image data, which would be a data source 120. In this embodiment, binary files are received from input application module 140 and sent to storage module 170, particularly in the online object storage element 172, where it is consumed by the processing module 160. In sequence, the text output is stored in the in-memory database 171, where is consumed by the output application module 150. All these actions are based on instructions sent by the orchestrating module 110.

In an alternative embodiment, the system 100 can be used to process an image, which would be a data source 120, into another image, which would be a data output 130. In this embodiment, binary files are received from input application module 140 and sent to storage module 170, particularly in the online object storage element 172, where is consumed by the processing module 160. In sequence, the image output is also stored in the online object storage element 172, where it is consumed by the output application module 150. All these actions are based on instructions sent by the orchestrating module 110.

In another alternative embodiment, the input can be a text, which would be a data source 120, which is processed into another text, which would be a data output 130. In this embodiment, text files are received from input application module 140 and sent to the storage module 170, such as in an in-memory database 171, where is consumed by the processing module 160. In sequence, the text output is also stored in the in-memory database 171, where it is consumed by the output application module 150. As they are text files, copies of the same are stored in the search engine storage 173. All these actions are based on instructions sent by the orchestrating module 110.

In another alternative embodiment, the input can be an audio file, which would be a data source 120, processed into a text, which would be a data output 130. In this embodiment, audio files are received from input application module 140 and sent to storage module 170, particularly in the online object storage element 172, where it is consumed by a data engineering processing block 161 that transforms the file in an intermediary binary file, which is also stored in the online object storage element 172. In sequence, the binary file is consumed by a data science block 162. The text output of this process is stored in the in-memory database 171, where is consumed by the output application module 150. All these actions are based on instructions sent by the orchestrating module 110.

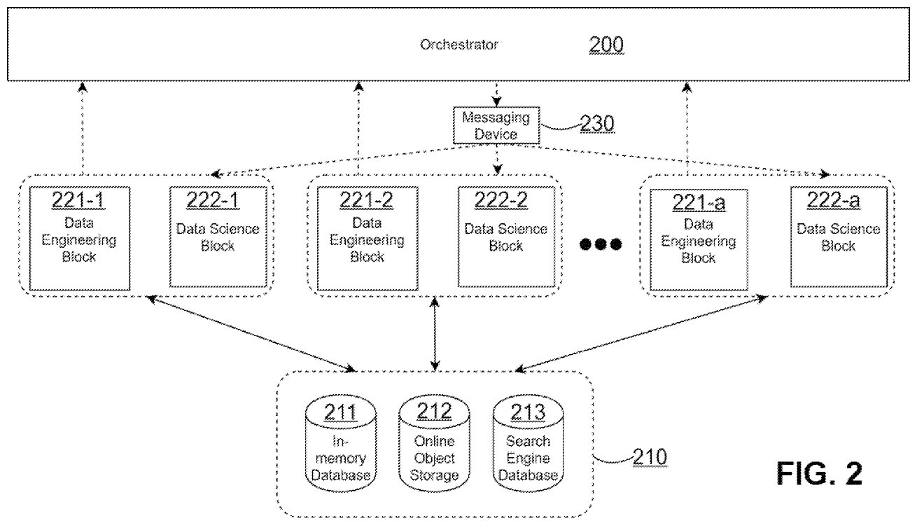

Referring now to the diagram of FIG. 2, and in at least some embodiments of the present disclosure, the orchestrator module 200 can trigger the processing of multiple data engineering and data science processes in parallel. The messaging module 230 is responsible for triggering multiple processing blocks 221-a, 222-a and the orchestrator module 200 is responsible for collecting the status of each processing block 221-a, 222-a to continue the dataflow.

In a preferred embodiment, the orchestrator module 200 can deal with multiple requests at the same time. For instance, this occurs when new data is available to be processed when previous data processing is not yet finished. The messaging module 230 communicates each element of data engineering and data science blocks, e.g. 221-1 and 222-1, in sequential ordering. Every block is responsible for writing and reading data from each required storage module 210.

In a preferred embodiment, the data input can be an image and the data engineering blocks 221 can output an image. These blocks will read the image from the online object storage element 212 and write its output also to the online object storage element 212. In this scenario, data science blocks 222 can input an image and output a text. Therefore, data will be read from storage in the online object storage element 212 and output will be written to the in-memory database 211, since the output is a text data.

While various embodiments of devices and systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. The present disclosure includes disclosure of a system for managing data engineering and data science processes, comprising:
an input application module configured to read data inputs from data sources;
a processing module configured to apply functions of data science and data engineering processing on the data inputs;
a storage module configured to store data inputs, processed data, and output data;
an output application module configured to collect the processed data and writes data outputs;
an orchestrator module configured to manage the dataflow with predefined rules on which modules to be triggered in accordance with the data inputs and data outputs; and
a messaging module configured to communicate the processing module and the orchestrator module.

2. The system of claim 1, wherein the orchestrator module comprises a memory unit which stores the predefined rules on which modules to be triggered in accordance with the data inputs and data outputs.

3. The system of claim 1, wherein the orchestrator module comprises a memory unit which stores the address of each module.

4. The system of claim 1, wherein the processing module comprises a data engineering block and a data science block.

5. The system of claim 1, wherein the storage module comprises an in-memory database, an online object storage element, and a search engine database.

6. The system of claim 1, wherein the storage module comprises an in-memory database which stores text data, an online object storage element which stores binary files, and a search engine database which stores track files of system logs and text outputs.

7. The system of claim 1, wherein the processing module is configured to apply multiple functions of data engineering and data science simultaneously.

8. The system of claim 1, wherein the predefined rules involve one or more rules for organizing the sequence of processes to be applied to the data after the extraction of the data from the data source, wherein the one or more predefined rules define a batch process or a real-time process, and wherein the one or more sequence rules comprise rules for parsing, transforming and analyzing the data.

9. The system of claim 1, wherein the processing module process each of the multiple data records in near real-time, preferably by the processing engine the results from previous processes.

10. A non-transitory computer-readable storage medium having computer-executable instructions stored thereon for, when executed by a processor of a computer, performing a method for managing data engineering and data science processes, the method comprising:
reading data inputs from data sources using an input application module;
applying functions of data science and data engineering processing on the data inputs using a processing module configured to apply the functions of data science and data engineering;
storing data inputs, processed data, and output data on a storage module;
collecting the processed data and writes data outputs using an output application module;
managing the dataflow with predefined rules on which modules to be triggered in accordance with the data inputs and data outputs using an orchestrator module; and
communicating the processing module and the orchestrator module using a messaging module.

11. A method of performing a method for managing data engineering and data science processes, comprising the steps of:
reading data inputs from data sources using an input application module;
applying functions of data science and data engineering processing on the data inputs using a processing module configured to apply the functions of data science and data engineering;
storing data inputs, processed data, and output data on a storage module;
collecting the processed data and writes data outputs using an output application module;
managing the dataflow with predefined rules on which modules to be triggered in accordance with the data inputs and data outputs using an orchestrator module; and
communicating the processing module and the orchestrator module using a messaging module.

12. The method of claim 11, wherein the orchestrator module comprises a memory unit which stores the predefined rules on which modules to be triggered in accordance with the data inputs and data outputs.

13. The method of claim 11, wherein the step of managing the dataflow is performed using the orchestrator module that comprises a memory unit which stores the address of each module.

14. The method of claim 11, wherein the processing module comprises a data engineering block and a data science block.

15. The method of claim 11, wherein the storage module comprises an in-memory database, an online object storage element, and a search engine database.

16. The method of claim 11, wherein the storage module comprises an in-memory database which stores text data, an online object storage element which stores binary files, and a search engine database which stores track files of system logs and text outputs.

17. The method of claim 11, wherein the processing module is configured to apply multiple functions of data engineering and data science simultaneously.

18. The method of claim 11, wherein the predefined rules involve one or more rules for organizing the sequence of processes to be applied to the data after the extraction of the data from the data source, wherein the one or more predefined rules define a batch process or a real-time process, and wherein the one or more sequence rules comprise rules for parsing, transforming and analyzing the data.

19. The method of claim 11, wherein the processing module process each of the multiple data records in near real-time, preferably by the processing engine the results from previous processes.
